(19) United States
(12) Patent Application Publication
(10) Pub. No.: US 2017/0163105 A1
(43) Pub. Date: Jun. 8, 2017

(54) STATOR ASSEMBLY UNIT OF DRIVE MOTOR

(71) Applicant: Hyundai Motor Company, Seoul (KR)

(72) Inventors: GaEun Lee, Seongnam (KR); Kyoungbum Kim, Yongin (KR); Young Jin Seo, Yongin (KR); MyungKyu Jeong, Seoul (KR)

(21) Appl. No.: 15/180,405

(22) Filed: Jun. 13, 2016

(30) Foreign Application Priority Data
Dec. 4, 2015 (KR) 10-2015-0172491

(51) Int. Cl. H02K 1/20; H02K 9/197; H02K 5/18; H02K 1/18

(52) U.S. Cl. CPC H02K 1/20; H02K 1/185; H02K 9/197; H02K 5/18

(57) ABSTRACT

A stator assembly unit of a drive motor is provided. The stator assembly unit of a drive motor includes a housing and a securing member that has an annular shape is mounted to an interior circumferential surface of the housing and is configured to secure a stator core. A cooling water flow passage through which cooling water flows is integrally formed in the securing member and cooling fins are formed at both sides of a flow center of the cooling water.

### CROSS-REFERENCE TO RELATED APPLICATION

This application claims priority to and the benefit of Korean Patent Application No. 10-2015-0172491 filed in the Korean Intellectual Property Office on Dec. 4, 2015, the entire contents of which are incorporated herein by reference.

### BACKGROUND

(a) Field of the Invention

The present invention relates to a drive motor, and more particularly, to a stator assembly unit of a drive motor, in which a stator core of the drive motor is fixedly secured to an inside of a housing to enable cooling of the stator core.

(b) Description of the Related Art

In general, a hybrid electric vehicle effectively combines two or more types of power sources for driving the vehicle. Many hybrid electric vehicles are driven by an engine which obtains torque by combusting a fuel (e.g., a fossil fuel such as gasoline) and an electric motor (hereinafter referred to as a “drive motor”) which obtains torque from a battery. Since the hybrid electric vehicle uses both mechanical energy of the engine and electrical energy of the battery, uses optimal operation regions of the engine and the drive motor, and recovers energy upon braking, fuel efficiency is improved and energy is used more efficiently.

The drive motor for the hybrid electric vehicle includes a stator core of a concentrated winding split core type and the stator core is fixedly mounted within a housing and a rotor is mounted integrally to a shaft of the drive motor. The concentrated winding split core type is a type in which the stator core has a plurality of split cores each with a stator coil wound thereon and that are connected together.

Since the drive motor generates a substantial amount of heat by an eddy current at the stator core, the drive motor is required to be cool to prevent the drive motor from being damaged by the heat to secure consistent stable operation. The cooling of the drive motor such as a permanent magnet synchronous motor (PMSM) is important for improving efficiency of the drive motor and protecting parts (e.g., a permanent magnet, a winding coil, and so on). When a temperature of the permanent magnet reaches a predetermined level, demagnetization in which magnetic intensity is lost occurs, thereby deteriorating the efficiency of the drive motor.

Methods for cooling the drive motor include an oil cooling method which uses oil and a water cooling method which uses cooling water. In the water cooling method, the stator core is fixedly secured to the housing and a support ring for cooling the stator core is mounted between the stator core and the housing. A cooling water flow passage is formed between an external circumferential surface of the support ring and an interior circumferential surface of the housing for causing the cooling water to flow through a groove formed in the external circumferential surface of the support ring, and an O-ring is provided thereto for sealing the cooling water flow passage.

In the related art, the cooling water flows through the cooling water flow passage between the external circumferential surface of the support ring and the interior circumferential surface of the housing, enabling cooling of the heat generated at the stator core with the cooling water. However, since the stator assembly unit has the O-ring disposed between the external circumferential surface of the support ring and the interior circumferential surface of the housing for sealing the cooling water flow passage and the support ring for securing the stator core, damage to the O-ring during assembly of the support ring may occur, or it may be degraded by the heat of the stator core, thus decreasing the airtightness of the cooling water flow passage.

The above information disclosed in this section is merely for enhancement of understanding of the background of the invention and therefore it may contain information that does not form the prior art that is already known in this country to a person of ordinary skill in the art.

### SUMMARY

The present invention provides a stator assembly unit of a drive motor having advantages of improving airtightness and cooling performance of a cooling water flow passage for a support.

A stator assembly unit of a drive motor according to an exemplary embodiment of the present invention may include: a housing; and a securing member mounted to an interior circumferential surface of the housing and securing a stator core, wherein the securing member may have an annular shape, a cooling water flow passage for allowing flow of cooling water may be integrally formed in the securing member, and cooling fins may be formed at both sides of a flow center of the cooling water.

A plurality of apertures connected to the cooling water flow passage may be formed in an exterior circumferential surface of the securing member. The securing member may be manufactured by core-type low pressure casting to form the cooling member flow passage therein as one unit therewith. The cooling water flow passage may include: a main channel formed with a predetermined width at a center of the cooling water flow passage along a circumferential direction of the securing member; and sub-channels connected to the main channel and formed at both sides of the main channel. Each of the cooling fins may protrude from the sub-channel toward the main channel

The cooling water flow passage may be divided into a first flow section and a second flow section by the cooling fins, and a cross-sectional area of the second flow section may be greater than a cross-sectional area of the first flow section. A plurality of apertures connected to the cooling water flow passage may be formed in an exterior circumferential surface of the securing member, and the plurality of apertures may be connected to the second flow section. The securing member may be manufactured using a core that corresponds to a cross-sectional surface of the cooling water flow passage, and two molds that are coupled to and separated from each other with the core interposed therebetween.

A stator assembly unit of a drive motor according to an exemplary embodiment of the present invention may include: a housing; and a securing member mounted to an interior circumferential surface of the housing and securing a stator core, wherein the securing member may have an annular shape, a cooling water flow passage for allowing flow of cooling water may be integrally formed in the securing member, and cooling fins may be formed out of a flow center of the cooling water in the cooling water flow passage.

The cooling fins may be formed at both sides of the flow center of the cooling water. Since the cooling water flow passage may be formed in the securing member as a supporting ring as one unit therewith, dispensing with an O-ring in the related art, a number of components used for the stator assembly unit of the drive motor may be reduced, and a manufacturing cost of the stator assembly unit may be saved. In addition, the elimination of the O-ring prevents the cooling water flow passage from having reduced airtightness caused by damage and degradation of the O-ring. Further, since the cooling fins may be formed at both sides of the flow center of the cooling water, efficiency of cooling the stator core may be improved. Since the two molds coupled to and separated from each other are used to from the cross-sectional surface of the cooling water flow passage, a manufacturing process of the securing member and an extracting process of the core may be simplified.

### BRIEF DESCRIPTION OF THE DRAWINGS

The attached drawings illustrate exemplary embodiments of the present invention, and are provided for describing the present invention in more detail, but are not for limiting technical aspects of the present invention.

FIG. 1 is a cross-sectional view illustrating a stator assembly unit of a drive motor according to an exemplary embodiment of the present invention;

FIG. 2 is a perspective view illustrating a securing member applied to a stator assembly unit of a drive motor according to an exemplary embodiment of the present invention;

FIG. 3 is a cross-sectional view illustrating a securing member applied to a stator assembly unit of a drive motor according to an exemplary embodiment of the present invention;

FIG. 4 is a cross-sectional view illustrating a securing member according to a comparative example of the related art for describing an operational effect of a securing member according to an exemplary embodiment of the present invention;

FIG. 5 is a view for explaining a process of manufacturing a securing member applied to a stator assembly unit of a drive motor according to an exemplary embodiment of the present invention; and

FIG. 6 is a view for explaining a process of manufacturing a securing member according to a comparative example of the related art.

### DESCRIPTION OF SYMBOLS

1: housing

3: drive motor

10: stator core

20: rotation shaft

30: rotor core

50 and 150: securing member

61 and 161: cooling water flow passage

71: aperture

81 and 181: cooling fin

83: main channel

85: sub-channel

91: first flow section

92: second flow section

101 and 201: core

103 and 203: mold

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention. Parts not relevant to the present invention will be omitted for describing the present invention clearly, and throughout the specification, identical or similar parts will be given the same reference numbers.

Since size and thicknesses of elements are shown at will for convenience of description, and the present invention is not limited to the drawings without fail, but the thicknesses are enlarged for clearly expressing different parts and regions. Further, although terms including ordinal numbers, such as first or second, can be used for describing various elements, the elements are not confined by the terms, and are only used for making one element distinctive from other elements. In addition, the terms “. . . unit”, “. . . means”, “. . . er”, “. . . member” described in the specification mean units for processing at least one function or operation.

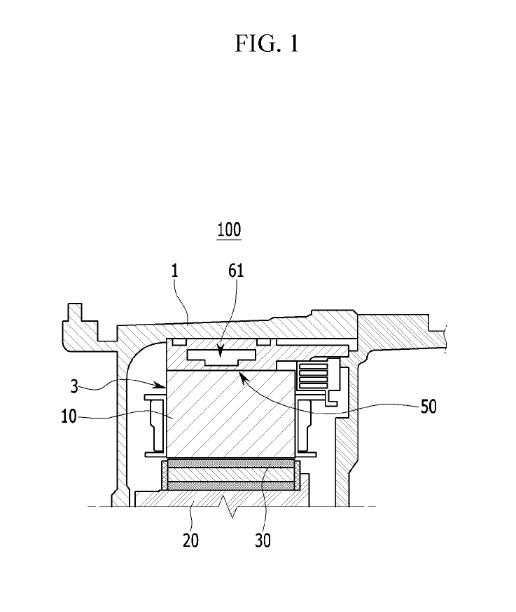

FIG. 1 is a cross-sectional view illustrating a stator assembly unit of a drive motor according to an exemplary embodiment of the present invention. Referring to FIG. 1, a stator assembly unit 100 according to an exemplary embodiment of the present invention may be applied to a drive motor 3 for a hybrid electric vehicle. The drive motor 3 may be a permanent magnet synchronous motor (PMSM) or a sound rotor synchronous motor (WRSM).

The drive motor 3 may include a stator core 10 fixedly mounted to an inside of a housing 1 and configured to generate a magnetic flux, and a rotor core 30 spaced apart from the stator core 10 by a predetermined gap and configured to rotate based on a rotation shaft 20. The drive motor 3 may be applied to an inner-rotor type of synchronous motor having the rotor core 30 disposed within the stator core 10. The stator core 10 may be of a concentrated winding split core type which has a plurality of split cores each with a stator coil (not shown) wound thereon.

The stator assembly unit 100 of the drive motor 3 may have a structure in which the stator core 10 may be fixedly secured to the housing 1 and may be cooled with a cooling agent (e.g., cooling water). In an exemplary embodiment of the present invention, the stator assembly unit 100 of the drive motor 3 may improve cooling performance on the stator core 10. The stator assembly unit 100 may include a securing member 50 mounted at an interior between the housing 1 and the stator core 10.

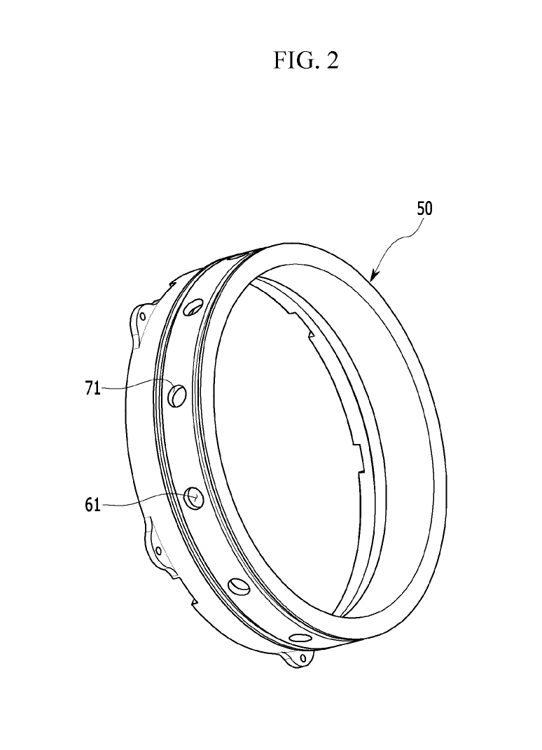

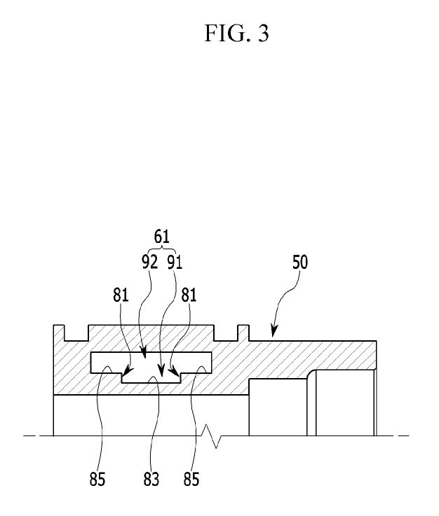

FIG. 2 is a perspective view illustrating a securing member applied to a stator assembly unit of a drive motor according to an exemplary embodiment of the present invention, and FIG. 3 is a cross-sectional view illustrating a securing member applied to a stator assembly unit of a drive motor according to an exemplary embodiment of the present invention.

Referring to FIGS. 1 to 3, the securing member 50 may be configured to support and secure the stator core 10 of the drive motor 3 within the housing 1 as well as cooling heat generated at the stator core 10 with the cooling water by a water cooling method. The securing member 50 may be a support ring having an annular shape, and may be mounted between the housing 1 and the stator core 10. The securing member 50 may be made of stainless steel having a similar thermal expansion coefficient to that of the stator core 10. The securing member 50 may include a cooling water flow passage 61 through which the cooling water may flow as a cooling agent to cool the stator core 10.

According to an exemplary embodiment of the present invention, as distinguished from the related art in which the cooling water flow passage is formed between the external circumferential surface of the support ring and the interior circumferential surface of the housing 1, the cooling water flow passage 61 may be formed integrally in the securing member 50. The securing member 50 may be manufactured by core-type low pressure casting to form the cooling water flow passage 61 therein as one unit therewith. In particular, the cooling water flow passage 61 may be formed as an annular inside space in the annular body of the securing member 50.

A plurality of apertures 71 connected to the cooling water flow passage 61 may be formed in an exterior circumferential surface of the securing member 50. The apertures 71 may be separately formed at a predetermined gap in the exterior circumferential surface of the securing member 50 along a circumferential direction of the securing member 50. For example, the aperture 71 may be formed as a core aperture (e.g., hollow space or hollow region) to form the cooling water flow passage 61 in the securing member 50, or as an inlet/outlet aperture for introduction and discharge of the cooling water. In addition, the aperture 71 may be formed as a connection aperture (e.g., a connection passage) for bringing the cooling water flowing along the cooling water flow passage 61 into contact with an inside wall of the housing 1.

Furthermore, in the cooling water flow passage 61 of the securing member 50, cooling fins 81 may be formed at both sides of a flow center of the cooling water. The cooling fins 81 may be formed out of the flow center of the cooling water in the cooling water flow passage 61. In other words, the cooling fins 81 may not be formed at the flow center of the cooling water. The cooling fins 81 may effectively transfer heat generated at the stator core 10 to the cooling water passage 61. Accordingly, the heat generated at the stator core 10 may be cooled more easily by the cooling water flowing along the cooling water flow passage 61.

Hereinafter, a horizontal direction in FIG. 3 is referred to as a width direction of the securing member 50. The cooling water flow passage 61 may include a main channel 83 and sub-channels 85. The main channel 83 may be formed with a predetermined width at a center of the cooling water flow passage 61 along the circumferential direction of the securing member 50. The main channel 83 may be formed in a groove shape along the circumferential direction of the securing member 50.

The sub-channels 85 may be connected to the main channel 83 inside the securing member 50, and may be formed at both sides of the main channel 83 in the width direction of the securing member 50. In other words, the main channel 83 may be formed with a predetermined width at the flow center of the cooling water, and may be formed between the sub-channels 85 based on the width direction of the securing member 50. Each of the cooling fins 81 may protrude or extend from the sub-channel 85 toward the main channel 83. In other words, each of the cooling fins 81 may be formed at a portion where the main channel 83 is connected with the sub-channels 85, and may form a right angle.

The cooling water flow passage 61 may be divided into a first flow section 91 and a second flow section 92 by the cooling fins 81. A cross-sectional area of the second flow section 92 may be greater than a cross-sectional area of the first flow section 91. The apertures 71 may be connected to the second flow section 92. In the exemplary embodiment of the present invention, since the securing member 50 may be mounted between the housing 1 and the stator core 10 and the cooling water flow passage 61 may be formed in the securing member 50 as one unit, the cooling water flowing through the cooling water flow passage 61 may cool the heat generated at the stator core 10.

In addition, since the cooling fins 81 may be formed at both sides of the flow center of the cooling water, the efficiency of cooling the stator core 10 may be improved. In other words, since the cooling fins 81 may effectively transfer the heat generated at the stator core 10 to the cooling water passage 61, the heat generated at the stator core 10 may be cooled more easily by the cooling water flowing along the cooling water flow passage 61.

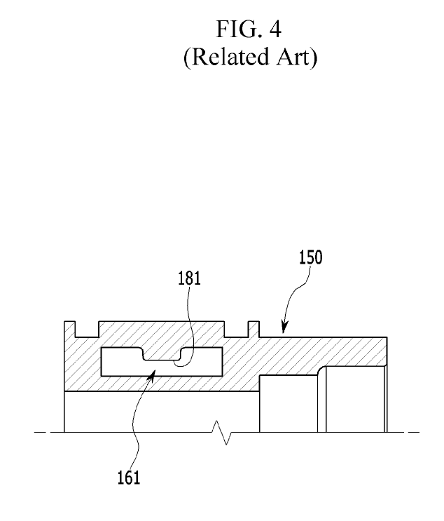

Hereinafter, an operational effect of the securing member according to an exemplary embodiment of the present invention will be described compared to a comparative example. FIG. 4 is a cross-sectional view illustrating a securing member according to a comparative example of the related art for describing an operational effect of a securing member according to an exemplary embodiment of the present invention.

In a comparative example shown in FIG. 4, a cooling fin 181 is provided as a single fin, and the cooling fin 181 is formed at a flow center of the cooling water in a cooling water flow passage 161 of a securing member 150. In particular, the cooling water flow passage 161 is formed along the circumferential direction of the securing member 150, and protrudes from a center of an exterior circumferential surface of the securing member 150. In contrast, in the exemplary embodiment of the present invention, the cooling fins 81 may not be formed at the flow center of the cooling water flow passage 61, and instead may be formed at both sides of the flow center of the cooling water flow passage 61.

Since the cooling fins 81 may be formed at both sides of the flow center of the cooling water flow passage 61 in the exemplary embodiment of the present invention and the cooling fin 181 is formed at the flow center of the cooling water flow passage 161 in the comparative example, a cross-sectional area of the cooling water flow passage 61 in the present invention is less than a cross-sectional area of the cooling water flow passage 161 of the related art.

Furthermore, a flow rate (Q), a cross-sectional area (A), and a flow speed (V) satisfy a relationship of Q=A×V. When the flow rate of the cooling water supplied to the cooling water flow passage 61 is the same as the flow rate of the cooling water supplied to the cooling water flow passage 161, since the cross-sectional area of the cooling water flow passage 61 is less than the cross-sectional area of the cooling water flow passage 161, the flow speed in the present invention may be increased compared to the comparative example of the related art.

Since the flow speed of the cooling water flowing through the cooling water flow passage 61 may be increased, cooling performance on the stator core 10 may be improved. The cooling water flow passage 61 may be formed integrally in the securing member 50 and thus, in the exemplary embodiment of the present invention, since the cooling water flow passage 61 may be formed in the securing member 50 as the supporting ring as one unit therewith, dispensing with the O-ring in the related art, a number of components used for the stator assembly unit 100 of the drive motor 3 may be reduced, and a manufacturing cost of the stator assembly unit 100 may be saved.

In addition, the elimination of the O-ring in the exemplary embodiment of the present invention may prevent the cooling water flow passage from having reduced airtightness caused by damage and degradation of the O-ring. Further, since the cooling fins 81 may be formed at both sides of the flow center of the cooling water, the efficiency of cooling the stator core 10 may be improved. The securing member 50 according to the exemplary embodiment of the present invention and the securing member 150 according to the comparative example are manufactured by core-type low pressure casting. Hereinafter, processes of manufacturing the securing members 50 and 150 will be described with reference to the accompanying drawings.

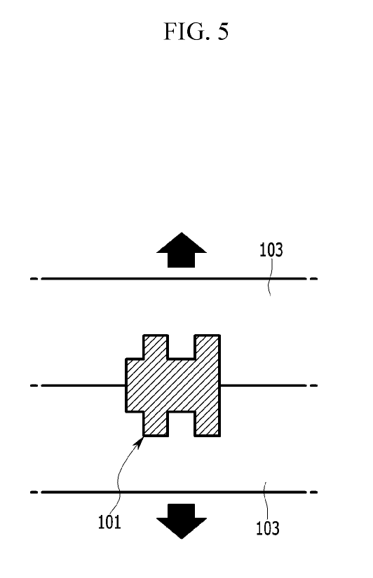

As shown in FIG. 5, a core 101 having protrusions that extend vertically (based on the drawing) may form the cross-sectional surface of the cooling water flow passage 61. Two molds 103 capable of being coupled to and separated from each other may be provided with the core 101 interposed therebetween in a vertical direction (based on the drawings).

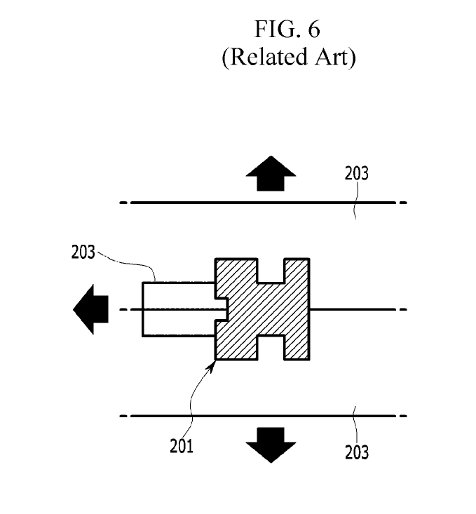

According to the exemplary embodiment of the present invention, since the two molds 103 capable of being coupled to and separated from each other may be used to form the cross-sectional surface of the cooling water flow passage 61, a manufacturing process of the securing member 50 and an extracting process of the core 101 may be simplified. However, as shown in FIG. 6, in the comparative example of the related art, a core 201 having protrusions that extend vertically and a groove recessed from the left side (based on the drawing) is provided to form the cross-sectional surface of the cooling water flow passage 161.

Three molds 203 capable of being coupled and separated to and from each other may be provided with the core 201 interposed thereamong in a vertical direction and a horizontal direction (based on the drawings). According to the comparative example of the related art, since the three molds 203 are used to form the cross-sectional surface of the cooling water flow passage 161, a manufacturing process of the securing member 150 and an extracting process of the core 201 are more complex.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A stator assembly unit of a drive motor, comprising:
a housing; and
a securing member mounted to an interior circumferential surface of the housing and configured to secure a stator core,
wherein the securing member has an annular shape, a cooling water flow passage through which cooling water flows is integrally formed in the securing member, and cooling fins are formed at both sides of a flow center of the cooling water.

2. The stator assembly unit of claim 1, wherein a plurality of apertures connected to the cooling water flow passage are formed in an exterior circumferential surface of the securing member.

3. The stator assembly unit of claim 1, wherein the securing member is manufactured by core-type low pressure casting to form the cooling water flow passage therein as one unit therewith.

4. The stator assembly unit of claim 1, wherein the cooling water flow passage includes:
a main channel formed with a predetermined width at a center of the cooling water flow passage along a circumferential direction of the securing member; and
sub-channels connected to the main channel and formed at both sides of the main channel.

5. The stator assembly unit of claim 4, wherein each of the cooling fins protrudes from the sub-channel toward the main channel.

6. The stator assembly unit of claim 5, wherein the cooling water flow passage is divided into a first flow section and a second flow section by the cooling fins, and a cross-sectional area of the second flow section is greater than a cross-sectional area of the first flow section.

7. The stator assembly unit of claim 6, wherein a plurality of apertures connected to the cooling water flow passage are formed in an exterior circumferential surface of the securing member, and the plurality of apertures are connected to the second flow section.

8. The stator assembly unit of claim 1, wherein the securing member is manufactured by using a core that corresponds to a cross-sectional surface of the cooling water flow passage and two molds that are coupled to and separated from each other with the core interposed therebetween.

9. A stator assembly unit of a drive motor, comprising:
a housing; and
a securing member mounted to an interior circumferential surface of the housing and configured to secure a stator core,
wherein the securing member has an annular shape, a cooling water flow passage through which cooling water flows is integrally formed in the securing member, and cooling fins are formed out of a flow center of the cooling water in the cooling water flow passage.

10. The stator assembly unit of claim 9, wherein the cooling fins are formed at both sides of the flow center of the cooling water.
